(19) United States
(12) Patent Application Publication
(10) Pub. No.: US 2009/0002603 A1
(43) Pub. Date: Jan. 1, 2009

(54) Blue Emitting Alkaline Earth Chlorophosphate Phosphor for Cold Cathode Fluorescent Lamp, and Cold Cathode Fluorescent Lamp and Color Liquid Crystal Display Using Same

(75) Inventors: Reiji Otsuka, Kanagawa-ken (JP); Masayo Matsuoka, Kanagawa-ken (JP)

Correspondence Address: KANESAKA BERNER AND PARTNERS LLP, 1700 DIAGONAL RD, SUITE 310, ALEXANDRIA, VA, 22314-2848, US

(73) Assignee: Kasei Optonix, Ltd, Odawara-shi (JP)

(21) Appl. No.: 12/087,109

(22) PCT Filed: Dec. 26, 2006
(86) PCT No.: PCT/JP2006/326360

§ 371 Date: Jun. 26, 2008

(30) Foreign Application Priority Data
Dec. 27, 2005 (JP) 2005-376389

(51) Int. Cl. G02F 1/1335; H01J 63/04; C01F 17/00

(52) U.S. Cl. 349/69; 313/486; 423/263

(57) ABSTRACT

This invention provides an alkaline earth chlorophosphate phosphor for a blue light emitting cold cathode fluorescent lamp, represented by (Sr₁₀₋ₖ₋ₗ₋ₘ₋ₙBaₖCaₗMgₘEuₙ)(PO₄)₆Cl₂ wherein 0<k≦1.5, 0≦1≦1.2, 0≦m≦0.25 and 0.05≦n≦0.3, a cold cathode fluorescent lamp using a blue light emitting phosphor represented by (Sr₁₀₋ₖ₋ₗ₋ₘ₋ₙBaₖCaₗMgₘEuₙ)(PO₄)₆Cl₂ wherein 0≦k≦1.5, 0≦1≦1.2, 0≦m≦0.25 and 0.05≦n≦0.3, and a color liquid crystal display device using the lamp as backlight. The phosphor causes no significant lowering in luminescence brightness over time and no significant change in luminescent chromaticity over time under excitation with ultraviolet light at a wavelength of 180 to 300 nm and, particularly when used as backlight for a liquid crystal display, can realize image display with a wide color reproduction range.

### TECHNICAL FIELD

This invention relates to a blue emitting alkaline earth chlorophosphate phosphor for a cold cathode fluorescent lamp which exhibits high luminance by irradiating ultraviolet radiation of 180 to 300 nm, less decrease in emission luminance (degradation of luminance) and less variation of emission color point (color shift) with the passage of time, a cold cathode fluorescent lamp of high luminous flux which results in beautiful display images of wide color reproducibility range when the phosphor is used as a phosphor layer for a liquid display backlight, and a color liquid display in which the cold cathode fluorescent lamp is used as a backlight.

### BACKGROUND OF THE INVENTION

Recently, there has become popular a flat panel display (FPD), typically such as a liquid crystal display (LCD) and a plasma display (PDP). FPD includes a so-called emission type display such as PDP in which image-composing pixels arranged on a panel emit themselves and a non-emission type display such as LCD in which the pixels do not emit themselves but a backlight incorporated therewith is used. Images are made up on the panel by means of a combination of the backlight and a liquid crystal shutter, while a color filter is further used to realize color images.

LCD was conventionally used as a display for personal computers but, in recent years, its use has been rapidly spreading in the field where a color image display is required, such as monitors and color TV. In such the use, it is very important to more truly reproduce colors of objects and, at least, a range of color reproducibility comparable to that of a color picture tube, CRT, is required.

On the other hand, a cold cathode fluorescent lamp has been mainly used as a backlight for LCD. A fluorescent lamp of three component type becomes more popular than those lamps of a phosphor layer type comprising a halophosphate phosphor as a single component. While in the above mentioned three component type, there is used a phosphor layer comprising a phosphor which shows strong emission spectrum peaks of narrower full width at half maximum near each wavelength band of 450, 540 and 610 nm. The phosphor for the three component type has been developed for the purpose of improving brightness and color rendering to use as illumination.

As a green emitting phosphor for illuminating fluorescent lamps, there has been principally used a lanthanum phosphate phosphor, LAP phosphor, coactivated with trivalent cerium, Ce³⁺, and trivalent terbium, Tb³⁺, having an emission spectrum compatible with the spectral luminous efficiency and, as a blue emitting phosphor, in contrast, there have been principally used a barium-magnesium aluminate phosphor activated with divalent europium, Eu²⁺, having emission spectrum of relatively wider full width at half maximum, such as BaMgAl₁₀O₁₇:Eu or an alkaline earth chlorophosphate phosphor activated with Eu²⁺ such as (Sr, Ba, Ca, Mg)₁₀(PO₄)₆Cl₂:Eu to improve the color rendering, respectively.

These phosphors developed for the purpose of using for illumination have also used for the cold cathode fluorescent lamp as the backlight of LCD without modifying their properties, which causes a decrease in the range of color reproducibility even if such the fluorescent lamp is high luminous flux. An increase in thickness of a color filter for LCD as a counter measure results in the wider range of color reproducibility but inconveniently decreases the luminance because of lower transmittance. Therefore, it has been expected to develop a cold cathode fluorescent lamp of wide range of color reproducibility when the above mentioned phosphors are used for the backlight of LCD under a condition of high luminous flux. According to Japanese Patent No. A-2001-228319, for example, there is described that a green emitting phosphor is investigated to widen the range of color reproducibility of LCD and a beautiful display picture comparable to an ordinary and bright color CRT of wide range of color reproducibility can be obtained by using an illuminant having an emitting peak in the wavelength range from 500 to 540 nm as a backlight of LCD, etc. However, no example is described therein about a blue emitting phosphor with the view of widening the range of color reproducibility.

Among blue emitting phosphors for the three component type fluorescent lamp, the Eu²⁺ activated barium-magnesium aluminate phosphor would arouse trouble such as a decrease in the luminous flux maintenance caused by adsorption of mercury or color shift due to ultraviolet degradation of the phosphor, while the Eu²⁺ activated alkaline earth chlorophosphate phosphor has a lower luminous flux compared with that of the aluminate phosphor although problems of the above mentioned luminous flux maintenance or color shift are not remarkable.

In order to prevent adsorption of mercury and improve the luminous flux maintenance, there is obtained a fluorescent lamp which exhibits high luminous flux maintenance after lightening by coating a rare earth compound on the surface of phosphor particles (see, Japanese Registered Patent No. 2,784,255). According to this method, however, the luminous flux maintenance is not necessarily improved to the full depending on kinds of phosphors when such a phosphor is used for the lamp.

Further, when a blue emitting phosphor of wider full width at half maximum, which is developed to use for illumination, is used as a phosphor layer of a cold cathode fluorescent lamp comprising a backlight of a color liquid crystal display, it is troublesome that the range of blue color reproducibility is narrowed.

In the case of an Eu²⁺ activated strontium chlorophosphate phosphor represented a compositional formula: Sr₁₀(PO₄)₆Cl₂:Eu (SCA phosphor) of relatively narrower full width at half maximum, there arouse not only trouble of lower luminous flux compared with that of the Eu²⁺ activated barium-magnesium aluminate phosphor but problems such degradation of luminance due to adsorption of mercury and color shift due to ultraviolet degradation. As a result, these phosphors have not been put to practical use yet.

### DISCLOSURE OF THE INVENTION

The invention has been completed to solve conventional problems as described above. Accordingly, it is an object of this invention to provide a blue emitting alkaline earth chlorophosphate phosphor for a cold cathode fluorescent lamp of high luminance when ultraviolet radiation of 180 to 300 nm is irradiated and less degradation of emission luminance with the passage of time, a cold cathode fluorescent lamp of high luminous flux, less degradation of luminance and color shift of emitting colors with the passage of time and wider range of color reproducibility when the phosphor is used as a phosphor layer for a backlight of LCD and other similar devices, and a color liquid display in which the cold cathode fluorescent lamp is used as a backlight.

In order to achieve the above mentioned object, the inventors have extensively investigated Eu²⁺-activated alkaline earth chlorophosphate phosphors, especially an Eu²⁺-activated strontium chlorophosphate phosphor (SCA phosphor) from standpoints of kinds and contents of alkaline earth metals composing the alkaline earth chlorophospate as a matrix, an Eu content in activating agents and compositions of the phosphor, so that the phosphor for a cold cathode fluorescent lamp used as the backlight of LCD has an emission spectrum to match satisfactorily with a color filter, and analyzed in detail effects of difference in compositions to emitting properties.

It has been conventionally known that alkaline earth chlorophosphate phosphors comprising alkaline earth such as Ba, Ca, Mg, etc. except Sr cause increases both in the full width at half maximum of emission spectrum and the emission color point, i.e., the value y, of CIE colorimetric system, compared with the SCA phosphor, (Sr, Eu)₁₀(PO₄)₆Cl₂.

As a result our investigation, however, it has been found that the full width at half maximum of emission spectrum and the emission color point (y) of CIE colorimetric system can be unexpectedly kept in a decreased state where the colorimetric purity of blue is predominantly high and, at the same time, the emission effect is improved when a part of Sr comprising the host crystal of the SCA phosphor is replaced by a specific amount of Ba, Ca and Mg, especially Ba as an alkaline earth metal. The luminous flux maintenance is improved by using the above mentioned phosphor as a phosphor layer of the cold cathode fluorescent lamp.

A curve A shown in FIG. 1 is an emission spectrum of an Eu²⁺ activated barium magnesium aluminate phosphor represented by a compositional formula: BaMgAl₁₀O₁₇:Eu which is a typical conventional blue phosphor of cold cathode fluorescent lamp for a backlight of LCD, while curves B and C are spectral transmittance of typical blue and green color filter used for a LCD display, respectively.

As shown in FIG. 1, matching of the emission spectrum with the spectral transmittance curve of the color filter is not good in the case of the conventional blue emitting component phosphor represented by the curve A. According to this invention, in contrast, it is possible to remarkably decrease the emission intensity in the blue green wavelength range around 500 nm and conversely increase it in the blue wavelength range of 445 to 455 nm by replacing Sr which comprises the SCA phosphor matrix with a specific amount of alkaline earth metals such as Ba, Ca and Mg. It has been found that emission constituents of the blue emitting phosphor in the wavelength range of 455 to 500 nm can be decreased because of relatively higher spectral transmittance in cases of blue and green color filters (see, curves B and C), although such constituents have been considered difficult to remove conventionally, thereby resulting in a blue emitting phosphor of better blue calorimetric purity and effective emission spectrum even when blue and green color filters are combined.

A cold cathode fluorescent lamp of high luminous flux is obtained when the above mentioned phosphor is used as a phosphor layer thereof, which is then used as a backlight of LCD, etc. to result in a display screen of wider range of color reproducibility, thereby completing this invention.

Subject matters of the invention are as in the following.
(1) In a cold cathode fluorescent lamp in which a phosphor layer is formed on an inner wall of a transparent envelope and mercury and rare gas are encapsulated in said envelope, said phosphor layer being emitted by ultraviolet wavelength of 180 to 300 nm irradiated by discharging said mercury, said phosphor layer comprises an alkaline earth chlorophosphate phosphor used for a blue emitting cold cathode fluorescent lamp and is represented by the following compositional formula:

(Sr₁₀₋ₖ₋ₗ₋ₘ₋ₙBaₖCaₗMgₘEuₙ)(PO₄)₆Cl₂
wherein k, l, m and n are numeral value satisfied by conditions of 0≦k≦1.5, 0≦1≦1.2, 0≦m≦0.25 and 0.05≦n≦0.3, respectively.
(2) A cold cathode fluorescent lamp described in the item (1) in which k is numeral value satisfied by a condition of 0<k≦1.5.
(3) A cold cathode fluorescent lamp described in the item (1) or (2) in which k is numeral value satisfied by a condition of 0.005≦k≦1.5.
(4) A cold cathode fluorescent lamp described in any item (1), (2) or (3) emitting an emission in which emission spectral peak wavelength (λₑₘₚ) of the alkaline earth chlorophosphate phosphor used for said blue emitting cold cathode fluorescent lamp is in a wavelength range of 445 to 455, full width at half maximum (Δλₚ)_{1/2} of an emission peak thereof is 35 nm or less and color point (x, y) of CIE calorimetric system of emission color exhibits is 0.14≦x≦0.16 and 0.02≦y≦0.06.
(5) A cold cathode fluorescent lamp described in the item (4) in which emission intensity ratio (I_{G}/I_{B}) is 0.12 or less wherein I_{B} and I_{G} represent emission intensity at said emission spectral peak wavelength (λₑₘₚ) and at 500 nm of said emission spectrum, respectively.
(6) A cold cathode fluorescent lamp described in any item (1) to (5) in which particle surface of said alkaline earth chlorophosphate phosphor used for a blue emitting cold cathode fluorescent lamp is coated with at least one of metal oxide, hydroxide or carbonate compounds.
(7) A cold cathode fluorescent lamp described in any item (1) to (6) in which said phosphor layer comprises a green emitting phosphor having a emission peak in the wavelength range of 505 to 535 nm.
(8) A cold cathode fluorescent lamp described in the item (7) in which said green emitting phosphor is an Eu²⁺- and Mn²⁺-coactivated alkaline earth aluminate phosphor.
(9) A cold cathode fluorescent lamp described in the item (8) in which said Eu²⁺- and Mn²⁺-coactivated alkaline earth aluminate phosphor is represented by the following compositional formula:

a(P_{1-c}Eu_{c})O.(Q_{1-d}Mn_{d})O.bAl₂O₃
wherein P represents at least one of alkaline earth metal elements including Ba, Sr and Ca, Q represents at least one of divalent metal elements including Mg and Zn, and a, b, c and d represent numeral value satisfied by conditions of 0.8≦a≦1.2, 4.5≦b≦5.5, 0.05≦c≦0.25 and 0.2≦d≦0.4, respectively.
(10) A cold cathode fluorescent lamp described in any item (7) to (9) in which said phosphor layer comprises a red emitting phosphor showing an emission peak in the wavelength range from 610 to 630 nm.
(11) A cold cathode fluorescent lamp described in the item (10) in which said red emitting phosphor is at least one of Eu³⁺-activated rare earth oxide phosphors, Eu³⁺-activated rare earth vanadate phosphors and Eu³⁺-activated rare earth phosphate-vanadate phosphors.
(12) A cold cathode fluorescent lamp described in any item (1) to (11) in which the emission color point (x, y) of CIE colorimetric system of emission color is in the range of 0.23≦x≦0.35, 0.18≦y≦0.35.
(13) In a color liquid crystal display device incorporated with plural liquid crystal elements consisted of liquid crystals which function as an optical shutter, a color filter corresponding to each of said plural liquid crystal elements and having at least three coloring matters of red, green and blue and a backlight for transmittance type lighting, said backlight comprises a cold cathode fluorescent lamp described in any item (1) to (12).
(14) A blue emitting alkaline earth chlorophosphate phosphor used for a cold cathode fluorescent lamp which compositional formula is represented by

(Sr₁₀₋ₖ₋ₗ₋ₘ₋ₙBaₖCaₗMgₘEuₙ)(PO₄)₆Cl₂
wherein k, l, m and n are numeral value satisfied by conditions of 0<k≦1.5, 0≦1≦1.2, 0≦m≦0.25 and 0.05≦n≦0.3, respectively.
(15) A blue emitting alkaline earth chlorophosphate phosphor described in the item (14) in which said k is numeral value satisfied by a condition of 0.005≦k≦1.5.
(16) A blue emitting alkaline earth chlorophosphate phosphor described in the item (14) or (15) in which emission spectral peak wavelength is 445 to 455 nm, full width at half maximum of an emission peak thereof is 35 nm or less and emission color point (x, y) of CIE calorimetric system of emission color is in the range of 0.14≦x≦0.16 and 0.02≦y≦0.06.
(17) A blue emitting alkaline earth chlorophosphate phosphor described in any item (14) to (16) in which an emission intensity ratio ((I_{G}/I_{B}) is 0.12 wherein I_{B} and I_{G} represent emission intensity of an spectral peak in said wavelength range and at 500 nm, respectively.
(18) A blue emitting alkaline earth chlorophosphate phosphor described in any item (14) to (17) which surface is coated with at least one of metal oxide, hydroxide and carbonate compounds.

### BRIEF DESCRIPTION OF THE DRAWING

FIG. 1 is an emission spectrum of a conventional Eu²⁺-activated barium-magnesium aluminate phosphor and spectral transmittance curves of blue and green color filters.

FIG. 2 is an emission spectrum of an Eu²⁺-activated alkaline earth chlorophosphate phosphor of this invention and spectral transmittance curves of blue and green color filters.

FIG. 3 shows a correlation of Ba content (k) in an Eu²⁺-activated alkaline earth chlorophosphate phosphor of this invention with an emission intensity ratio (I_{G}/I_{B}) thereof, wherein I_{B} and I_{G} represent emission peak intensity in the wavelength range of 445 to 455 nm and at 500 nm, respectively.

FIG. 4 shows a correlation of Ba content in an Eu²⁺-activated alkaline earth chlorophosphate phosphor of this invention with relative emission luminance thereof.

FIG. 5 shows a correlation of Ba content in an Eu²⁺-activated alkaline earth chlorophosphate phosphor of this invention with luminous flux maintenance of a cold cathode fluorescent lamp in which the present phosphor is used as a phosphor layer.

FIG. 6 shows a correlation of Ca content in an Eu²⁺-activated alkaline earth chlorophosphate phosphor of this invention with an emission intensity ratio (I_{G}/I_{B}) thereof, wherein I_{B} and I_{G} represent emission peak intensity in the wavelength range of 445 to 455 nm and at 500 nm, respectively.

FIG. 7 shows a correlation of Ca content in an Eu²⁺-activated alkaline earth chlorophosphate phosphor of this invention with relative emission luminance thereof.

FIG. 8 shows a correlation of Mg content in an Eu²⁺-activated alkaline earth chlorophosphate phosphor of this invention with an emission intensity ratio (I_{G}/I_{B}) thereof, wherein I_{B} and I_{G} represent emission peak intensity in the wavelength range of 445 to 455 nm and at 500 nm, respectively.

FIG. 9 shows a correlation of Mg content in an Eu²⁺-activated alkaline earth chlorophosphate phosphor of this invention with relative emission luminance thereof.

FIG. 10 shows a correlation of Eu concentration in an Eu²⁺-activated alkaline earth chlorophosphate phosphor of this invention with relative emission luminance thereof.

FIG. 11 shows a correlation of Eu concentration in an Eu²⁺-activated alkaline earth chlorophosphate phosphor of this invention with an emission intensity ratio (I_{G}/I_{B}) thereof, wherein I_{B} and I_{G} represent emission peak intensity in the wavelength range of 445 to 455 nm and at 500 nm, respectively.

### EFFECT OF THE INVENTION

The present alkaline earth chlorophosphate phosphor used for a cold cathode fluorescent lamp has a composition as described above, while its emission intensity is weak in the range of blue green wavelength around 500 nm but is strong in the range of blue wavelength from 445 to 455 nm, so that color matching thereof with a color filter is improved and its colorimetric purity is superior to conventional blue emitting phosphors used for a cold cathode fluorescent lamp such as, for typical example, an Eu²⁺-activated barium-magnesium aluminate phosphor (BAM phosphor).

In particular, an alkaline earth chlolophosphate phosphor used for a cold cathode fluorescent lamp of this invention which comprises a certain amount of Ba in the matrix composition results in less decrease in the luminous flux maintenance caused by adsorption of mercury or the color shift caused by ultraviolet degradation and, consequently, the present cold cathode fluorescent lamp in which this phosphor is used for a phosphor layer as a blue emitting component is high luminous flux in nature and capable of keeping high luminance with the passage of time even if the lamp is continuously lightened for a long time.

Accordingly, a cold cathode fluorescent lamp of high luminous flux is obtained when the phosphor of this invention is used for the phosphor layer as the blue emitting component, which is useful as a backlight of LCD, etc. to display bright and beautiful images of wide range of color reproducibility.

The above mentioned effects are especially remarkable when a color temperature of the cold cathode fluorescent lamp is high, or a phosphor layer thereof comprises a green emitting phosphor having an emission peak in the wavelength range of 505 to 535 nm and a red emitting phosphor having an emission peak in the wavelength range of 610 to 630 nm.

### PREFERRED EMBODIMENTS OF THE INVENTION

There can be prepared the Eu²⁺-activated alkaline earth chlorophosphate phosphor of the invention (hereinafter simply referred to as the present blue emitting phosphor) used for a cold cathode fluorescent lamp similarly as conventional Eu²⁺-activated alkaline earth chlorophosphate phosphors except that starting materials are blended to yield a predetermined composition.

The present blue emitting phosphor is prepared by charging a mixture of the following starting compounds of the phosphor:
1) alkaline earth metal phosphate as well as other phosphate compounds changeable to alkaline earth phosphate by a high temperature reaction thereof with alkaline earth metals, such as diammonium hydrogenphospate and hydrogen phosphate;
2) alkaline earth metal oxide or other compounds changeable to the similar oxide at high temperature, such as alkaline earth metal nitrate, carbonate and hydroxide;
3) alkaline earth metal chloride; and
4) Eu oxide or other Eu compound changeable to the similar oxide at high temperature, such as Eu nitrate, sulfate, carbonate, halide and hydroxide, in a ratio to stoichiometrically fit the following compositional formula:

(Sr₁₀₋ₖ₋ₗ₋ₘ₋ₙBaₖCaₗMgₘEuₙ)(PO₄)₆Cl₂
wherein k, l, m and n are numeral value satisfied by conditions of 0<k≦1.5, 0≦1≦1.2, 0≦m≦0.25 and 0.05≦n≦0.3, respectively,
   to a heat-resistant vessel and firing at 900 to 1,200° C. once or several times in a neutral gas atmosphere such as argon or nitrogen or in a reducing gas atmosphere such as nitrogen containing a small amount of hydrogen, or carbon monoxide.

When these starting compounds are subjected to firing, there may be further added a halogen or boron containing compound as a flux followed by firing. A method for preparing the present phosphor is not limited to such manners but any of conventionally known methods may be applicable if the composition is within the range of stoichiometric amounts as described above.

Further, there may be coated at least one of oxide, hydroxide and carbonate compound of metals, such as lanthanum, yttrium, aluminum, barium and strontium, in a predetermined amount on the surface of phosphor particles prepared as described above, thereby effectively inhibiting a decrease in the luminous flux maintenance caused by contamination of the phosphor in a phosphor layer due to mercury or other compounds during lightening of a cold cathode fluorescent lamp in which the phosphor is used as the phosphor layer. It is also possible to effectively inhibit a damage of the phosphor surface caused by ultraviolet radiation of 185 nm or shorter one of 200 nm or less in wavelength irradiated in the cold cathode luminescence lamp during lightening thereof. As a result, the luminance degradation of emission intensity with the passage of time is prevented, thereby preferably inhibiting a decrease in the luminous flux maintenance of the cold cathode fluorescent lamp.

Coating of at least one of metal oxide, hydroxide and carbonate compounds on the surface of phosphor particles is done by mixing the Eu²⁺-activated alkaline earth chlorophosphate phosphor prepared as described above with at least one of fine-powdered oxide, hydroxide and carbonate compounds of lanthanum, yttrium, aluminum, barium, strontium and the like in a predetermined amount in a solvent to form a slurry of the phosphor, which is further mixed thoroughly followed by dehydration and drying. Water is preferably used as the solvent in this process from a standpoint of easy handling, although alcohol such as ethanol or other organic solvents such as acetone may be used. Such a coated phosphor may also be prepared as in the following manner. In the slurried phosphor, there are poured a solution containing hydroxyl or carbonate ion and a solution containing metal ion capable of forming metal oxide or carbonate as a reaction product with the hydroxyl or carbonate ion, or a predetermined amount of water, desired soluble metal hydroxide or carbonate and a metal compound, which are then mixed thoroughly to form a metal oxide or carbonate compound to be sedimented and adhered on the surface of the phosphor. Further, the phosphor on which surface the metal oxide or carbonate compound is coated as described above is charged in a heat resistant vessel and fired once or several times at 400 to 900° C. in a neutral gas atmosphere such as argon and nitrogen or a reducing gas atmosphere such as nitrogen containing a small amount of hydrogen, and carbon monoxide to obtain the metal oxide coated phosphor of this invention.

An amount of at least one of metal oxide, hydroxide and carbonate compounds to be coated is necessarily 0.01% by weight or more of the phosphor to obtain a desirable effect of deposition, but an amount 5% by weight or more causes a decrease in the emission luminance and is not preferable.

Referring to the Eu²⁺-activated alkaline earth chlorophosphate phosphor represented by a compositional formula (Sr₁₀₋ₖ₋ₗ₋ₘ₋ₙBaₖCaₗMgₘEuₙ)(PO₄)₆Cl₂, there will be described a correlation of a matrix composition of the phosphor and concentration of an activating agent (Eu) with the emission luminance and that of respective emission intensity in two specific ranges of wavelength.

According to the above mentioned compositional formula, each content (molar quantity) of barium (Ba), calcium (Ca) and magnesium (Mg) and concentration (molar quantity) of europium (Eu) contained in one mole of the alkaline earth chlorophosphate represented by the compositional formula: (Sr₁₀₋ₖ₋ₗ₋ₘ₋ₙBaₖCaₗMgₘEuₙ)(PO₄)₆Cl₂ are designated by k, l, m and n, respectively. The term “relative emission luminance” as will appear occasionally below means value of emission luminance of a phosphor to be determined relative to that value of a blue emitting phosphor used for fluorescent lamps represented by a compositional formula of (Sr_{9.84}Ca_{0.01}Mg_{0.05}Eu_{0.1})(PO₄)₆Cl₂ as a standard, which is set at 100 for convenience when the standard phosphor is excited by ultraviolet radiation of 253.7 nm, i.e., the emission luminance of emission spectrum at peak wavelength of 447 nm.

FIG. 3 shows a correlation of emission intensity ratio (I_{G}/I_{B}) with the Ba content (k), wherein I_{B} and I_{G} represent intensity of emission peaks in the wavelength ranges from 445 to 455 nm and 500 nm, respectively, of emission spectrum, when an exemplary Eu²⁺-activated alkaline earth chlorophosphate phosphor is excited by ultraviolet radiation of 253.7 nm, in which each content of Ca (l) and Mg (m) and concentration of Eu (n) is 0.01, 0.05 and 0.1 mole, respectively, so that the phosphor is represented by a compositional formula of (Sr_{9.84-k}BaₖCa_{0.01}Mg_{0.05}Eu_{0.1})(PO₄)₆Cl₂.

As described above, when the phosphor is excited by ultraviolet radiation of 253.7 nm, the intensity of emission peaks in the range from 445 to 455 nm (blue wavelength range) and 500 nm of the emission spectrum are designated as I_{B} and I_{G}, respectively, and a ratio of the latter intensity to the former is referred to as “emission intensity ratio” (I_{G}/I_{B}).

More precisely, the emission intensity ratio (I_{G}/I_{B}) is a ratio of emission intensity of a green emitting component to that of a blue emitting component and thus, is considered as an index to evaluate the emission calorimetric purity of the phosphor, or the matching property with a blue color filter. The smaller the emission intensity ratio (I_{G}/I_{B}), the higher the calorimetric purity of a blue color is because emission of the blue component relatively increases compared with green one, which means that matching with the blue color filter of emission of the phosphor is satisfactory.

In the case of blue emitting phosphors in general, it is desirable to show emission of an emission spectrum which emission intensity ratio (I_{G}/I_{B}) is about 0.12 or less to increase the colorimetric purity of emission color and matching with a transmittance spectrum (spectral transmittance curve) of the blue color filter. Further, the value y on the color point coordinates based on CIE colorimetric system of emission color is preferably about 0.060 or less to increase the colorimetric purity and matching with the spectral transmittance curve of the blue color filter.

Similarly in the blue emitting phosphor of this invention, there have been intended to obtain the emission intensity ratio (I_{G}/I_{B}) 0.12 or less and the value y 0.060.

It is apparent from FIG. 3 that the emission intensity ratio (I_{G}/I_{B}) of the Eu²⁺-activated alkaline earth chlorophosphate phosphor begins to rise when the matrix contains Ba (k<0) and increases rapidly when the Ba content (k) is about 1.0 mole or more.

The emission intensity ratio (I_{G}/I_{B}) is about 0.12 when the Ba content is 1.5 or less (k≦1.5) and decreases with a decrease in the Ba content (k). This is because of a decrease in concentration of Eu existing in a Ba dominant crystal field and an increase thereof existing in a Sr dominant crystal field. As a result, the emission intensity ratio in the green wavelength range (I_{G}) near 500 nm is weakened and the colorimetric purity of blue is heightened relatively.

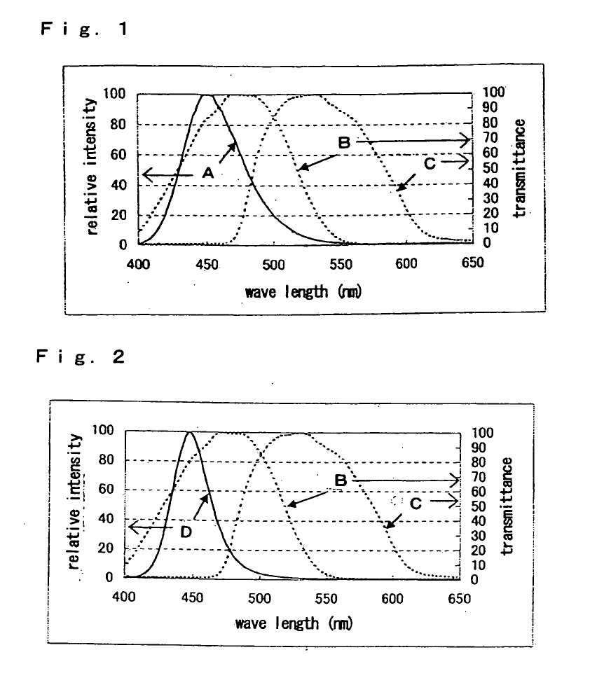

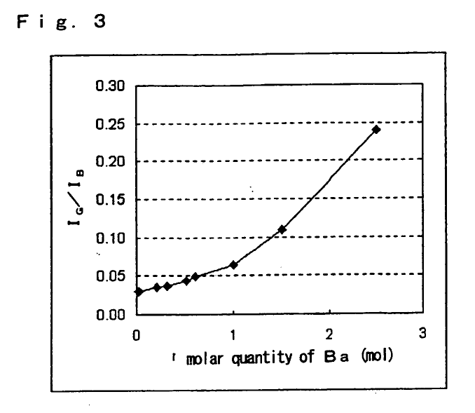

A curve D shown in FIG. 2 is an emission spectrum of the present blue emitting phosphor represented by a compositional formula (Sr_{9.7195}Ba_{0.025}Ca_{0.0055}Mg_{0.15}Eu_{0.1})—(PO₄)₆Cl₂, while curves B and C are spectral transmission curves of representative blue and green color filters used in LCD display, respectively. Comparison of the emission spectrum of the blue emitting phosphor (curve D in FIG. 2) with the spectral transmission curve of the blue color filter (curve B in FIG. 2) indicates that matching of the emission spectrum of the present blue emitting phosphor with the spectral transmittance distribution of the blue color filter is more satisfactory and losses of emission quantity due to the filter are improved and tends to decrease.

The full width at half maximum of emission spectrum, which is not shown, increases when the Ba content (k) is 1.0 mole or more, however, it has been confirmed that the full width at half maximum never be 35 nm or less if the Ba content is 1.5 mole or less (k≦1.5). It has been further confirmed that the value y expressed by CIE colorimetric system increases continuously with an increase in the Ba content (k) and drops down to 0.060 or less (y≦0.06) when the Ba content is 1.5 mole or less (k≦1.5).

Such full width at half maximum of the emission spectrum is also a parameter to indicate a matching degree of emission of the phosphor with the blue color filter similarly as the value y of the color point based on CIE colorimetric system of the emission color and the emission intensity ratio (I_{G}/I_{B}). Thus, a decrease in the full width at half maximum of the emission spectrum and the value y on the color point coordinates indicating the emission color means that matching with the blue color filter is satisfactory and the colorimetric purity is improved to decrease losses of the emission quantity.

When attention is given only to construction of the emission spectrum as described above, it is simply preferable to decrease the Ba concentration from a viewpoint of matching with the blue color filter, however, the result to be obtained is not necessarily satisfactory from a viewpoint of luminance.

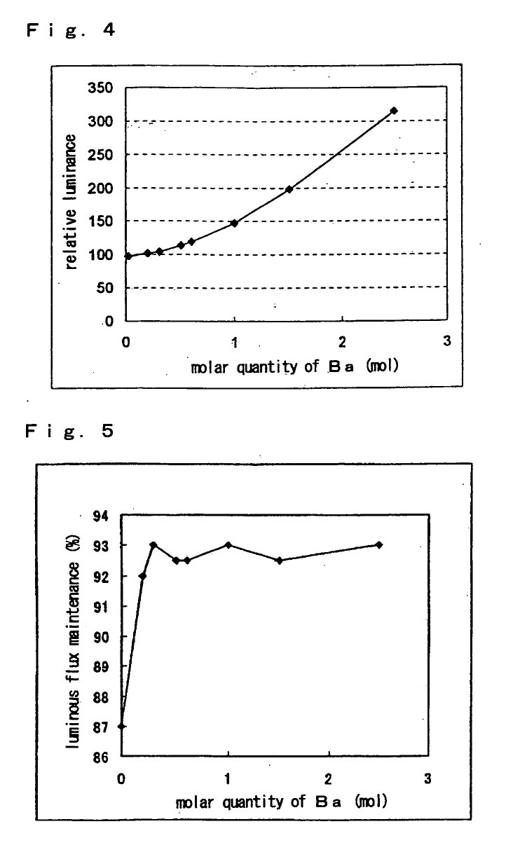

FIG. 4 is a graph showing relationship between the Ba content (k) in an Eu²⁺-activated alkaline earth activated chlorophosphate phosphor represented by a compositional formula: (Sr_{9.84-k}BaₖCa_{0.01}Mg_{0.05}Eu_{0.1})(PO₄)₆Cl₂ and emission luminance thereof when the phosphor is excited by ultraviolet radiation of wavelength at 253.7 nm.

It can be clearly seen a phenomenon from FIG. 4 that the emission luminance when the phosphor is excited by ultraviolet radiation of wavelength at 253.7 nm exceedingly depends on the Ba content (k) in the matrix composition and increases with an increase in the value k.

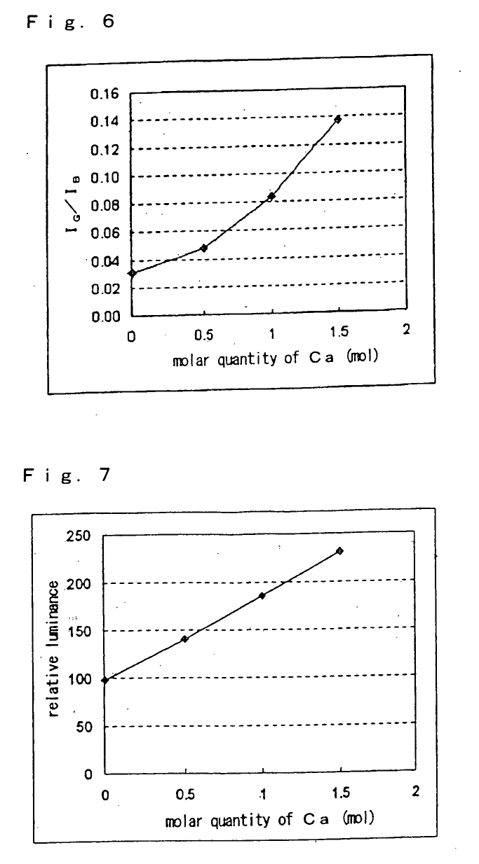

FIG. 5 is a graph showing relationship between the Ba content (k) of blue emitting Eu²⁺-activated alkaline earth activated chlorophosphate phosphors and the luminous flux maintenance which will be determined as in the following. The phosphors are represented by the above mentioned formula: (Sr_{9.84-k}BaₖCa_{0.01}Mg_{0.05}Eu_{0.1})(PO₄)₆Cl₂ in which the value k is variable. First of all, a white emitting cold cathode fluorescent lamp are prepared in a similar manner as will be described in Example 1 in which each phosphor layer thereof comprises the blue emitting phosphors as described above and in green- and red-emitting ones of Example 1, followed by determining a ratio of luminous flux, as the luminous flux maintenance, at the time after continuous lightening for 500 hours and at the time of initial lightening.

It is understood from FIG. 5 that the luminous flux maintenance of cold cathode luminescence lamps, in which the Eu²⁺-activated alkaline earth activated chloro-phosphate phosphor represented by the formula: (Sr_{9.84-k}BaₖCa_{0.01}Mg_{0.05}Eu_{0.1})(PO₄)₆Cl₂ is used as a phosphor layer, is improved with an increase in the Ba content (k) and, in particular, prominent improvement thereof is obtained when the value k is about 0.005 or more.

It is understandable from results of FIGS. 4 and 5 that the Ba content (k) in the phosphor is preferably increased to improve the emission luminance and the luminous flux maintenance of the cold cathode fluorescent lamps or to decrease the luminance degradation with the passage of time. However, the result of FIG. 3 proves that an increase in the Ba content in the phosphor causes a rise in the emission intensity ratio (I_{G}/I_{B}), thereby increasing emission of the green component and decreasing matching with the blue color filter.

Accordingly, the Ba content (k) as an essential component in the matrix composition of the present blue emitting phosphor, i.e., Eu²⁺-activated alkaline earth chlorophosphate phosphor, is preferably up to 1.5 (0<k≦1.5) from a viewpoint of practical use, more preferably 0.005 to 1.5 mole (0.005≦k≦1.5) and most preferably 0.005 to 1.0 mole (0.005≦k≦1.0) to keep the emission luminance as high as possible, emission of relatively decreased emission intensity ratio (I_{G}/I_{B}), satisfied matching with the blue color filter and the luminous flux maintenance of cold cathode fluorescent lamps at a predetermined value or above.

Then, there has been examined a correlation of contents of Ca and Mg (value 1 and m, respectively) as well as concentration of Eu (n) in the present blue emitting phosphor in which the Ba content is constant with the emission intensity ratio (I_{G}/I_{B}) and the emission luminance.

FIG. 6 is a graph showing correlation of the Ca content (l) in the phosphor matrix with the emission intensity ratio (I_{G}/I_{B}) determined in a similar manner as described above when the phosphor is excited by ultraviolet radiation of 253.7 nm. The phosphor used herein is an Eu²⁺-activated alkaline earth chlorophosphate phosphor represented by a compositional formula: (Sr_{9.825-1}Ba_{0.025}Ca₁Mg_{0.05}Eu_{0.1})(PO₄)₆Cl₂ in which contents of Ba and Mg are 0.025 and 0.05 mole, respectively, and concentration of Eu is 0.1 mole.

FIG. 6 proves that the emission intensity ratio (I_{G}/I_{B}) of the Eu²⁺-activated alkaline earth chlorophosphate phosphor tends to increase with an increase in the Ca content (1) and markedly increases when the value 1 is 0.5 or more.

As has been pointed out before, it is preferable to decrease the emission intensity ratio (I_{G}/I_{B}) to a level of 0.12 or less so as to improve matching of the colorimetric purity of emission color with transmittance spectral of the blue color filter. The emission intensity ratio (I_{G}/I_{B}) is 0.12 or less when the Ca content (1) is 1.3 or less (1≦1.3) and decreases with a decrease in the value 1. As a result, the emission intensity (I_{G}) in the range around 500 nm is weakened to raise the colorimetric purity of blue and, as shown in FIG. 2, matching with the blue color filter is satisfactory and losses of the emission quantity are improved to decrease them. Further, the emission color point (y) based on CIE colorimetric system of the emission color also increases with an increase in the Ca content (l) but the value y is 0.060 or less when the value 1 is 1.2 mole or less (1≦1.2), which results in satisfactory matching with the blue color filter and lesser losses of the emission quantity.

FIG. 7 is a graph showing relationship between the Ca content (l) in the above mentioned Eu²⁺-activated alkaline earth chlorophosphate phosphor represented by the compositional formula: (Sr_{9.825-1}Ba_{0.025}Ca₁Mg_{0.05}Eu_{0.1})(PO₄)₆Cl₂ and the emission luminance as relative value when the phosphor is excited by ultraviolet radiation of wavelength at 253.7 nm.

It is clear from FIG. 7 that the emission luminance when the phosphor is excited by ultraviolet radiation of wavelength at 253.7 nm is greatly depends on the Ca content (1) and is improved with an increase in the value 1.

Considering results of FIGS. 6 and 7, a requirement for satisfying both high luminance and favorable matching with the blue color filter is that the Ca content (1) is preferably 0 to 1.2 mole (0≦1≦1.2) and more preferably 0 to 0.7 mole (0≦1≦0.7).

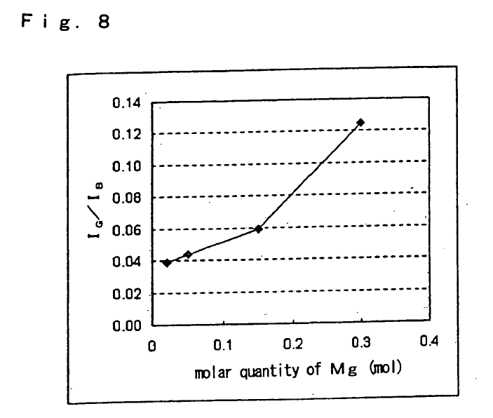

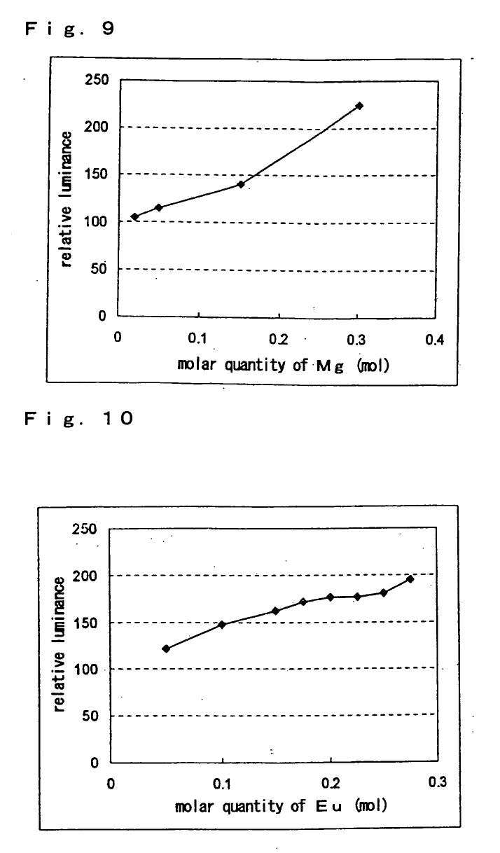

FIG. 8 is a graph showing relationship between the Mg content (m) in the phosphor matrix with the emission intensity ratio (I_{G}/I_{B}) determined in a similar manner as described above when the phosphor is excited by ultraviolet radiation of wavelength at 253.7 nm. The phosphor used herein is an Eu²⁺-activated alkaline earth chlorophosphate phosphor represented by a compositional formula: (Sr_{9.39-m}Ba_{0.5}Ca_{0.01}MgₘEu_{0.1})(PO₄)₆Cl₂ in which contents of Ba and Ca are 0.5 and 0.01 mole, respectively, and concentration of Eu is 0.1 mole.

FIG. 8 proves that the emission intensity ratio (I_{G}/I_{B}) in the phosphor increases when the Mg content is 0.15 mole or more.

As has been described above, the emission intensity ratio (I_{G}/I_{B}) is preferably about 0.12 or less to raise matching of the calorimetric purity of emission color with the transmittance spectrum of the blue color filter but the emission intensity ratio (I_{G}/I_{B}) is 0.12 or less when the Mg content (m) is 0.28 or less (m≦0.28) and decreases with a decrease in the Mg content. As a result, the emission intensity (I_{G}) in the range around 500 nm is weakened to raise the colorimetric purity of blue and, as shown in FIG. 2, matching with the blue color filter is satisfactory and losses of the emission quantity are improved to decrease them. Further, the emission color point (y) based on CIE colorimetric system of the emission color also increases with an increase in the Mg content (m) but the value y is 0.060 or less when the value m is 0.25 mole or less (m≦0.25), which results in satisfactory matching with the blue color filter and lesser losses of the emission quantity.

FIG. 9 is a graph showing relationship between the Mg content (m) in the above mentioned Eu²⁺-activated alkaline earth chlorophosphate phosphor represented by the compositional formula: (Sr_{9.39-m}Ba_{0.5}Ca_{0.01}MgₘEu_{0.1})(PO₄)₆Cl₂ and the emission luminance as relative value when the phosphor is excited by ultraviolet radiation of wavelength at 253.7 nm.

It is clear from FIG. 9 that the emission luminance when the phosphor is excited by ultraviolet radiation of wavelength at 253.7 nm is greatly depends on the Mg content (m) and shows a phenomenon of improvement thereof with an increase in the value m.

A requirement for satisfying both high luminance and favorable matching with the blue color filter is that the Mg content (m) is 0 to 0.25 mole (0≦m≦0.25) and preferably 0 to 0.15 mole (0≦m≦0.15).

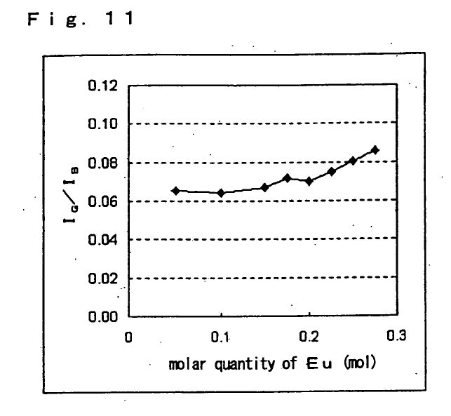

FIG. 10 is a graph showing relationship between the Eu concentration (n) of a Eu²⁺-activated alkaline earth chlorophosphate phosphor represented by a compositional formula: (Sr_{9.34-n}Ba_{0.5}Ca_{0.01}Mg_{0.15}Euₙ)(PO₄)₆Cl₂ in which contents of Ba(k), Ca(l) and Mg(m) are 0.5 (k=0.5), 0.01 (l=0.01), and 0.15 (l=0.15) mole, respectively, with the emission luminance (relative value) determined when the phosphor is excited by ultraviolet radiation of wavelength at 253.7 nm.

It is clear from FIG. 10 that the above mentioned emission luminance extensively depends on the Eu concentration (n) and increases with an increase in the concentration.

FIG. 11 is a graph showing correlation of the Eu concentration (n) in the phosphor matrix with the emission intensity ratio (I_{G}/I_{B}) determined in a similar manner as described above when the phosphor is excited by ultraviolet radiation of wavelength at 253.7 nm. The phosphor used herein is the above mentioned Eu²⁺-activated alkaline earth chlorophosphate phosphor represented by the compositional formula: (Sr_{9.34-n}Ba_{0.5}Ca_{0.01}Mg_{0.15}Euₙ)(PO₄)₆Cl₂.

FIG. 11 proves that a peak intensity ratio (I_{G}/I_{B}) of the phosphor is also depends on the Eu concentration (n) and the emission intensity ratio (I_{G}/I_{B}) increases with a raise in the Eu concentration. The reason why is that the emission peak at 445 to 455 nm shifts to longer wavelength side when the Eu concentration increases and, as a result, the emission intensity in the blue green region near 500 nm increases, thereby the colorimetric purity of blue being decreased. The emission color point (y) based on ICE colorimetric system of emission color increases in the Eu concentration of 0.2 mole or more.

In table 1, there are shown changes in the luminous flux maintenance of white emitting cold cathode fluorescent lamps and their color shift of emission color depending on phosphor compositions. The white emitting cold cathode fluorescent lamps prepared in a similar manner as will be described in Example 1 comprise blue emitting Eu²⁺-activated strontium chlorophosphate phosphors containing 0.1 mole of Eu in concentration (n) and green- and red-emitting phosphors of Example 1 as their phosphor layers. Each of these cold cathode fluorescent lamps is lightened continuously, while the luminous flux and the emission color point (x, y) are determined just after initial lightening and after 500-hour continuous lightening to evaluate, depending on compositions of the blue emitting phosphors used as phosphor layers, the luminous flux maintenance as value of luminous flux of each lamp in percentage after 500-hour continuous lightening and the color shift of emission color as differences (Δx, Δy) in the value x and the value y just after initial lightening and after 500-hour continuous lightening.

TABLE 1

| | Luminous Flux | Color Shift | |
|---|---|---|---|
| | Maintenance | (Change in Color Point) | |
| Phosphor Composition | (%) | (Δx) | (Δy) |
| (Sr_{9.9}Eu_{0.1})(PO₄)₆Cl₂ | 85 | 0.0093 | 0.0136 |
| (Sr_{9.899}Ba_{0.001}Eu_{0.1})(PO₄)₆Cl₂ | 89 | 0.0060 | 0.0068 |
| (Sr_{9.897}Ba_{0.003}Eu_{0.1})(PO₄)₆Cl₂ | 89 | 0.0054 | 0.0061 |
| (Sr_{9.895}Ba_{0.005}Eu_{0.1})(PO₄)₆Cl₂ | 91 | 0.0040 | 0.0050 |

In cold cathode fluorescent lamps in which Eu²⁺-activated strontium chlorophosphate phosphors are used as the blue emitting phosphor, the Ba content (k) is increased to gradually raise the emitting luminous maintenance when the Sr in the phosphor matrix composition is replaced by a small amount of Ba, as shown in Table 1. Accordingly, the luminous flux maintenance is improved and the color shift after continuous lightening is decreased when these blue emitting phosphors are used for such lamps.

From viewpoints to raise the colorimetric purity of blue color and obtain satisfactory matching with the blue color filter under an excited condition at 253.7 nm in wavelength and, in addition, to obtain emission of high luminance, increase the luminous flux maintenance and decrease the variation of emission color point (color shift) with the passage of time when the phosphor of this invention is used as a phosphor layer of a cold cathode fluorescent lamp, the Ba content (k) contained in one mole of alkaline earth chlorophosphate: (Sr₁₀₋ₖ₋ₗ₋ₘ₋ₙBaₖCaₗMgₘEuₙ)(PO₄)₆Cl₂ is preferably in the range of 0 to 1.5 mole (0<k≦1.5), more preferably, 0.005 to 1.5 mole (0.005≦k≦1.5) and most preferably 0.005 to 1.0 (0.005≦k≦1.0) thereby resulting in high colorimetric purity of blue color of the blue emitting phosphor.

Further, from a viewpoint to obtain high emission luminance and blue emission of high calorimetric purity of blue color, contents of Ca and Mg (value l and m) and concentration of Eu (n) are preferably in ranges of 0 to 1.2 mole (0≦1≦1.2), 0 to 0.25 mole (0≦m≦0.25) and 0.05 to 0.3 mole (0.05≦n≦0.3), respectively, in the above mentioned composition.

As has been described above, a matrix composition of the present Eu²⁺-activated alkaline earth chlorophosphate phosphor is specified to adjust to a predetermined Ba content so that more preferable blue emitting phosphors used for a cold cathode fluorescent lamp can be prepared.

Preferably, a total molar quantity of phosphate ion (PO₄) contained in starting materials of the present phosphor is slightly excessive than a stoichiometric quantity thereof. Thus, it is preferably to use a mixture of starting materials prepared by blending and mixing the materials to provide a total molar quantity of phosphate ion (PO₄) of about 6.0 to 6.09, i.e., 6.0<(PO)/(Sr₁₀₋ₖ₋ₗ₋ₘ₋ₙBaₖCaₗMgₘEuₙ)<6.09.

The alkaline earth chlorophosphate phosphor of this invention is also useful as a phosphor for high load devices such as LED, a rare gas lamp or field emission lamp other than a phosphor layer used for a cold cathode fluorescent lamp.

A cold cathode fluorescent lamp of this invention will be now described. The present cold cathode fluorescent lamp is similar to conventional ones except that a phosphor layer formed on an inner wall of a glass tube comprises the above mentioned Eu²⁺-activated alkaline earth chlorophosphate phosphor represented by a compositional formula: (Sr₁₀₋ₖ₋ₗ₋ₘ₋ₙBaₖCaₗMgₘEuₙ)(PO₄)₆Cl₂ wherein k, l, m and n are numeral value satisfied by conditions of 0≦k≦1.5, 0≦1≦1.2, 0≦m≦0.25 and 0.05≦n≦0.3, respectively.

A slurry of the phosphor is prepared by dispersing the Eu²⁺-activated alkaline earth chlorophosphate phosphor represented by the compositional formula as described above in a solvent such as water and butyl acetate together with a binder such as polyethylene oxide and nitrocellulose, which is then sucked up into a transparent slender tube such as a glass tube to coat on the inner wall followed by drying and baking treatments. After that, a pair of electrodes is fixed on predetermined positions, while inside of the tube is evacuated to charge a rare gas under pressure, such as argon-neon (Ar—Ne), and mercury vapor followed by sealing both ends of the tube to yield the present cold cathode fluorescent lamp. The electrode is fixed on both ends of the tube similarly as a conventional cold cathode fluorescent lamp.

There may be used an Eu²⁺-activated alkaline earth chlorophosphate phosphor which comprises no Ba in the matrix component, i.e., k=0 in the above mentioned compositional formula, as a phosphor layer of the cold cathode fluorescent lamp of this invention, however, it is more preferable to use the present phosphor comprising Ba as an essential component in the matrix composition, the value k in the compositional formula being in the range of 0<k≦1.5 from viewpoints to improve the luminous flux and the luminous flux maintenance of the cold cathode fluorescent lamp and to decrease the emission color shift with the passage of time.

It is also preferable to use the present phosphor in which phosphor particles are coated with at least one of metal oxide, hydroxide and carbonate compounds from viewpoints to decrease the emission color shift of the present cold cathode fluorescent lamp with the passage of time and to inhibit a decrease in the luminous flux maintenance of the lamp. Especially, when the matrix composition comprises no Ba or the Ba content (k) is 0.005 or less, the present blue emitting phosphor (Eu²⁺-activated alkaline earth chlorophosphate phosphor) is coated with at least one of metal oxide, hydroxide and carbonates compounds and used as a phosphor layer of the cold cathode fluorescent lamp, which is remarkably effective to inhibit a decrease in the emission color shift with passage of time and the luminous flux maintenance.

When the present blue emitting phosphor is used as a phosphor layer of the cold cathode fluorescent lamp, the lamp of relatively high color temperature is preferable, because the luminous flux from the lamp is more increased and emission of higher luminance is obtained compared with a conventional similar lamp comprising an Eu²⁺-activated barium-magnesium aluminate phosphor (BAM phosphor) as a blue emitting phosphor. The reason why is that the higher the color temperature of the lamp, the more a rate of blue emitting component to white increases, so that a blending rate of the green emitting phosphor can be increased by using the blue emitting phosphor of high calorimetric purity.

Accordingly, it is preferable to use the present blue emitting phosphor for the cold cathode fluorescent lamps, especially those lamps in which the emission color point (x, y) based on CIE colorimetric system of emission color is in the range of, for example, 0.23≦x≦0.35 and 0.18≦y≦0.35, from a viewpoint of the luminous flux.

Further, when the present cold cathode fluorescent lamp is used as a backlight of a liquid crystal display of this invention, the luminance of the liquid crystal display increases compared with conventional lamps, thereby resulting in a liquid crystal display of wider color reproducibility range because of high colorimetric purity of the blue emitting component used in the present cold cathode fluorescent lamp.

It is thus preferable to use the present cold cathode fluorescent lamps for the liquid crystal display of this invention, especially those lamps in which the emission color point (x, y) based on CIE colorimetric system of emission color is in the range of, for example, 0.23≦x≦0.35 and 0.18≦y≦0.35, from viewpoints to widen the colorimetric reproducibility and also to raise the white luminance of the liquid crystal display. When the present cold cathode fluorescent lamp is used as a backlight, there can be obtained a liquid crystal display of wide colorimetric reproducibility range and high luminance.

Furthermore, when the present blue emitting phosphor is used as a phosphor layer of the cold cathode fluorescent lamp of this invention, there may be additionally used a green emitting phosphor having an emission peak in the wavelength range of 505 to 535 nm as a phosphor layer together with the blue emitting phosphor, thereby resulting in a cold cathode fluorescent lamp useful for the liquid crystal display of wide calorimetric reproducibility range and high luminance.

Such an advantage of this invention is due to satisfactory matching with the color filter. When the green emitting phosphor having an emission peak in the wavelength range of 505 to 535 nm is used for the cold cathode fluorescent lamp instead of a conventional phosphor having an emission peak in the wavelength range around 540 nm, the range of colorimetric reproducibility of green color is widened but that of blue color is reduced, which exerts an evil influence thereupon. In a blue emitting component of the cold cathode fluorescent lamp, which is the blue emitting phosphor of this invention, an emitting component of wavelength range from 505 to 535 nm is quite small and the colorimetric purity is high and, for that reason, a decrease in the colorimetric purity is decreased to make the purity satisfactory even if an emission of wavelength range from 505 to 535 nm emitted by the green emitting phosphor partially transmits through the blue color filter.

The green emitting phosphor having an emission peak in the wavelength range of 505 to 535 nm to be used in combination with the blue emitting phosphor of this invention is preferably an Eu²⁺ and Mn²⁺-coactivated alkaline earth aluminate phosphor and, in particular, an alkaline earth aluminate phosphor used for the cold cathode fluorescent lamp, which emits by ultraviolet radiation in the wavelength range of 180 to 300 nm and is represented by the following compositional formula:

a(P_{1-c}Eu_{c})O.(Q_{1-d}Mn_{d})O.bAl₂O₃

wherein P represents at least one of alkaline earth metal elements including Ba, Sr and Ca, Q represents at least one of divalent metal elements including Mg and Zn, and a, b, c and d represent numeral value satisfied by conditions of 0.8≦a≦1.2, 4.5≦b≦5.5, 0.05≦c≦0.25 and 0.2≦d≦0.4, respectively. The green emitting phosphor as described above has no emission peak in the wavelength range of 445 to 455 nm and, if such a peak exists, the intensity is very weak so that influence of broad blue emission thereof to the blue emission component decreases, thereby raising effects of the blue emitting phosphor greatly.

Similarly, when the blue emitting phosphor of this invention is used as a phosphor layer of the present cold cathode fluorescent lamp, a red emitting phosphor having an emission peak in the wavelength range of 610 to 630 nm is used as a phosphor layer together with the blue emitting phosphor of this invention to obtain a cold cathode fluorescent lamp useful for a liquid crystal display of wider calorimetric reproducibility range.

The preferable red emitting phosphor having an emission peak in the wavelength range of 610 to 630 nm includes, in particular, Eu³⁺-activated rare earth oxide, Eu³⁺-activated rare earth vanadate and Eu³⁺-activated rare earth phosphate-vanadate phosphors. Especially, when the red emitting phosphor having a peak of longer wavelength is used, the range of colorimetric reproducibility can be further widened.

In addition, when the red emitting phosphor as described above is used together with the blue emitting phosphor of this invention and the green emitting one as a phosphor layer of the cold cathode fluorescent lamp, there is obtained such the lamp of wider colorimetric reproducibility range, which is useful for the liquid crystal display of this invention.

Structure of the present liquid crystal display is similar to conventional ones except that the cold cathode fluorescent lamp is used as a backlight thereof. Due to high luminance and wide colorimetric reproducibility range of the present cold cathode luminescent lamp, the present liquid crystal display using the lamp as a backlight also results in high luminance and wide calorimetric reproducibility.

### EXAMPLES

This invention will be detailed in the following examples.

### Example 1

Starting materials of a phosphor comprising:

| | | |
|---|---|---|
| SrHPO₄ | 1.18 | (mol) |
| Eu₂O₃ | 0.0097 | |
| SrCO₃ | 0.430 | |
| BaCO₃ | 0.097 | |
| MgCO₃ | 0.029 | |
| CaCO₃ | 0.0005 | |
| SrCl₂ | 0.390 | |

were thoroughly mixed to form a mixture of starting materials of the phosphor, charged in a crucible followed by capping and fired in a steam containing nitrogen-hydrogen mixed atmosphere at a maximum temperature of 1,000° C. for 12 hours including heating-up and cooling-down periods.

The thus formed powder was then subjected to dispersing, washing, drying and screening treatments to yield an Eu²⁺-activated strontium-barium-calcium-magnesium chlorophosphate phosphor represented by a compositional formula: (Sr_{9.2475}Ba_{0.5}Ca_{0.0025}Mg_{0.15}Eu_{0.1})(PO₄)₆Cl₂ as a product of Example 1. A portion of 0.195 mole in 0.39 mole of SrCl₂ was used as a flux which is often used to prepare phosphors.

The phosphor of this example has an emission spectrum of full width at half maximum (Δλ_{P})_{1/2} of 33 nm and an emission peak Δλ_{emP} at 447 nm. The emission intensity ratio I_{G}/I_{B} was 0.06, wherein I_{G} and I_{B} represent the emission intensity of emission peaks at 447 nm and 500 nm, while the emission color point (x, y) based on CIE colorimetric system of emission color was x=0.152 and y=0.041, which shows a practical emission color as a blue emitting phosphor.

The phosphor of this example was irradiated by ultraviolet radiation at 253.7 nm to determine the emission luminance, which was 140% of the data determined under the same condition in the SCA phosphor of Comparative Example 1 represented by a compositional formula: (Sr_{9.84}Ca_{0.01}Mg_{0.05}Eu_{0.1})(PO₄)₆Cl₂. Composition of the thus prepared phosphors is shown in table 2, while there are shown the full width at half maximum (Δλ_{P})_{1/2} of emission spectrum, the emission peak wavelength Δλ_{emP}, the emission intensity ratio I_{G}/I_{B}, the emission color point (x, y) and the relative emission luminance in Table 3, respectively.

One hundred parts by weight of mixture prepared by mixing the phosphor of Example 1 (blue emitting component phosphor), an Eu³⁺-activated yttrium oxide phosphor (red emitting component phosphor) and a Ce³⁺ and Tb³⁺-coactivated lanthanum phosphate phosphor (green emitting component phosphor) in a predetermined ratio was thoroughly mixed with 200 parts by weight of butyl acetate containing 1.1% of nitrocellulose and 0.7 part by weight of a borate binder to yield a phosphor slurry. The phosphor slurry was applied on an inner surface of a glass valve of 2.6 mm in outer diameter, 2.0 mm in inner diameter and 250 mm in pipe length, dried, subjected to a baking treatment at 650° C. for 15 minutes, followed by charging 5 mg of mercury and a Ne—Ar mixed gas under pressure of about 10 kPa into inside thereof and fixing electrodes to prepare a cold cathode fluorescent lamp of this Example 1, in which lamp current was 6 mA. A mixing ratio of this phosphor, the Eu³⁺-activated yttrium oxide phosphor and the Ce³⁺ and Tb³⁺-coactivated lanthanum phosphate phosphor was adjusted to result in a cold cathode fluorescent lamp showing the emission color point (x, y) of x=0.27 and y=0.24.

The luminous flux of the cold cathode fluorescent lamp of this Example 1 was 104.9% of the data determined in a phosphor of Comparative Example 3 which was prepared in a similar manner as this Example 1 except that the BAM phosphor was used as a blue emitting phosphor instead of the phosphor of Example 1.

Further, the cold cathode fluorescent lamp of this Example 1 was lightened continuously for 500 hours to determine the luminous flux at this time point to evaluate a ratio thereof to the luminous flux just after initial lightening as the luminous flux maintenance, which was 93% as shown in Table 3. On the other hand, the luminous flux maintenance of a cold cathode fluorescent lamp of Comparative Example 1 as will be described below was 87% when the determination was carried out similarly as the lamp of this Example 1. It is clear that the luminous flux maintenance of this cold cathode fluorescent lamp is markedly improved compared with the data determined by the sample of Comparative Example 1.

When the luminous flux maintenance was determined as described above, the emission color point (x, y) of emission color emitted by the cold cathode fluorescent lamps of this example and Comparative Example 1 was also determined to evaluate color shift (Δx, Δy) thereof from difference in color points just after initial lightning and after 500-hour continuous lightening. The color shift of this cold cathode fluorescent lamp was Δx=0.0034 and Δy=0.0050, while in the case of Comparative Example 1, Δx=0.0087 and Δy=0.0128, which demonstrates remarkable improvement in the color shift of this cold cathode fluorescent lamp compared with Comparative Example 1.

This cold cathode fluorescent lamp was used as a light source of backlight to prepare a liquid crystal display provided with red, green and blue color filters. When these three colors were displayed on the liquid crystal display, the emission color point (x, y) based on CIE calorimetric system of emission color was x=0.148 and y=0.065 for blue; x=0.302 and y=0.607 for green and x=0.624 and y=0.317 for red. Wide colorimetric reproducibility of 69.3% in NTSC ratio was obtained.

### Examples 2 to 6

There were prepared Eu²⁺-activated strontium-barium-calcium-magnesium chlorophosphate phosphors of Examples 2 to 6 represented by compositional formulas shown in Table 2 in a similar manner as described in Example 1 except that starting materials of the phosphor used in Example 1 were blended to form starting material mixtures comprising stoichiometric compositions shown in Table 2. Each amount of SrCl₂ to be blended was larger than stoichiometrically represented compositions, respectively, to use it as a flux similarly as described in Example 1.

TABLE 2
Phosphors

| | | Particle |
|---|---|---|
| Example & | | Surface |
| Comparative | Composition of Phosphor | Coating |
| Ex. 1 | (Sr_{9.2475}Ba_{0.5}Ca_{0.0025}Mg_{0.15}Eu_{0.1})(PO₄)₆Cl₂ | no |
| Ex. 2 | (Sr_{9.2445}Ba_{0.4}Ca_{0.0055}Mg_{0.15}Eu_{0.2})(PO₄)₆Cl₂ | no |
| Ex. 3 | (Sr_{9.7195}Ba_{0.025}Ca_{0.0055}Mg_{0.15}Eu_{0.1})(PO₄)₆Cl₂ | no |
| Ex. 4 | (Sr_{9.24}Ba_{0.5}Ca_{0.01}Mg_{0.15}Eu_{0.1})(PO₄)₆Cl₂ | no |
| Ex. 5 | (Sr_{8.7475}BaCa_{0.0025}Mg_{0.15}Eu_{0.1})(PO₄)₆Cl₂ | no |
| Ex. 6 | (Sr_{9.895}Ba_{0.005}Eu_{0.1})(PO₄)₆Cl₂ | no |
| Ex. 7 | (Sr_{9.84}Ca_{0.01}Mg_{0.05}Eu_{0.1})(PO₄)₆Cl₂ | Coated |
| Ex. 8 | (Sr_{9.7195}Ba_{0.025}Ca_{0.0055}Mg_{0.15}Eu_{0.1})(PO₄)₆Cl₂ | Coated |
| Comp. Ex. 1 | (Sr_{9.84}Ca_{0.01}Mg_{0.05}Eu_{0.1})(PO₄)₆Cl₂ | no |
| Comp. Ex. 2 | (Sr_{6.85}Ba₂CaMg_{0.05}Eu_{0.1})(PO₄)₆Cl₂ | no |

The thus prepared phosphors of these Examples 2 to 6 were excited by ultraviolet radiation of 253.7 nm to determine full width at half maximum (Δλₚ)_{1/2} of emission spectrum, emission peak wavelength λₑₘₚ, emission intensity ratio I_{G}/I_{B}, emission color point (x, y) and relative emission luminance thereof in a similar manner as described in Example 1. The results are shown in Table 3. It is clear from Table 3 that the phosphors of these examples have an emission color for practical use as a blue emitting phosphor.

A mixing amount of blue, green and red emitting phosphors was adjusted in a similar manner as described in Example 1 except that these phosphors were used instead of the sample of Example 1 to prepare cold cathode fluorescent lamps of these Examples 2 to 6 in which the emission color point (x, y) based on CIE colorimetric system of emission color is x=0.270 and y=0.240, respectively.

In Table 4, there are shown luminous flux of lightened cold cathode fluorescent lamps of these Examples 2 to 6, luminous flux maintenance, and color shift (Δx, Δy) determined in a similar manner as Example 1. The above mentioned luminous flux is relative value to what is determined in Comparative Example 3 as win be described below in which a cold cathode luminescent lamp is prepared similarly as Example 1 except that the BAM phosphor is used as a blue emitting phosphor instead of the phosphor used in Example 1.

### Comparative Example 1

There was prepared an Eu²⁺-activated strontium-calcium-magnesium chlorophosphate phosphor represented by a compositional formula: (Sr_{9.84}Ca_{0.01}Mg_{0.05}Eu_{0.1})(PO₄)₆Cl₂ as a product of Comparative Example 1 in a similar manner as described in Example 1 except that the following materials were used as starting materials of the phosphor:

| | | |
|---|---|---|
| SrHPO₄ | 1.2077 | (mol) |
| Eu₂O₃ | 0.0101 | |
| SrCO₃ | 0.5715 | |
| MgCO₃ | 0.0101 | |
| CaCO₃ | 0.0020 | |
| SrCl₂ | 0.4026 | |

The thus prepared phosphor was then irradiated by ultraviolet radiation of 253.7 nm to compare the emission luminance.

Further, this phosphor was excited by ultraviolet irradiation of 253.7 nm in a similar manner as described in Example 1 to determine full width at half maximum (Δλₚ)_{1/2} of emission spectrum, emission peak wavelength λₑₘₚ, emission intensity ratio I_{G}/I_{B}, emission color point (x, y) and relative emission luminance thereof. The results are shown in Table 3.

A mixing ratio of blue, green and red emitting phosphors was adjusted in a similar manner as described in Example 1 except this phosphor was used instead of the sample of Example 1 to prepare a cold a cathode fluorescent lamp of this example in which the emission color point (x, y) based on CIE calorimetric system of emission color is x=0.270 and y=0.240, respectively.

Luminous flux of the cold cathode fluorescent lamp of this Comparative Example 1 was 99.5% of the data determined by the lamp of Comparative Example 3 which is prepared in a similar manner as described in Example 1 except that the BAM phosphor is used instead of the phosphor of Example 1, while the luminous flux maintenance determined similarly as Example 1 was so low as 87%.

### Comparative Example 2

There was prepared an Eu²⁺-activated strontium-barium-calcium-magnesium chlorophosphate phosphor of Comparative Example 2 in a similar manner as described in Example 1 except that starting materials of the phosphor used in Example 1 were blended to form starting material mixtures comprising a stoichiometric composition shown in Table 2.

The composition of this phosphor is shown in Table 2. This phosphor was excited by ultraviolet radiation of 253.7 nm in a similar manner as described in Example 1 to determine full width at half maximum (Δλₚ)_{1/2} of emission spectrum, emission peak wavelength λₑₘₚ, emission intensity ratio I_{G}/I_{B}, emission color point (x, y) and relative emission luminance thereof. The results are shown in Table 3.

It is suggested by Table 3 that the phosphor of this Comparative Example 2, example is not useful for practical use from a viewpoint of the calorimetric purity of emission color.

A mixing ratio of blue, green and red emitting phosphors was adjusted in a similar manner as described in Example 1 except that this phosphor was used instead of the phosphor of Example 1 to prepare a cold cathode fluorescent lamp of this example in which the emission color point (x, y) based on CIE colorimetric system of emission color is x=0.270 and y=0.240, respectively.

The luminous flux of this cold cathode fluorescent lamp was 92.4% of the data determined by the lamp of Comparative Example 3 which is prepared in a similar manner as described in Example 1 except that the BAM phosphor is used instead of the sample of Example 1, while the luminous flux maintenance of this lamp determined similarly as Example 1 was 93%.

This cold cathode fluorescent lamp (Comparative Example 2) was used as a light source of backlight to prepare a liquid crystal display. When red, green and blue colors were displayed, the emission color point (x, y) based on CIE colorimetric system of emission color was x=0.256 and y=0.589 for green; x=0.136 and y=0.104 for blue and x=0.632 and y=0.320 for red, while the NTSC ratio was 67.8%.

### Comparative Example 3

A mixing ratio of blue, green and red emitting phosphors was adjusted in a similar manner as described in Example 1 except the BAM phosphor was used as a blue emitting phosphor instead of the phosphor of Example 1 to prepare a cold a cathode fluorescent lamp of Comparative Example 3 in which the emission color point (x, y) is x=0.270 and y=0.240, respectively, followed by comparing emission properties thereof with the cold cathode fluorescent lamp of this invention. The BAM phosphor is an Eu²⁺-activated barium-magnesium aluminate phosphor represented by a compositional formula: (Ba_{0.9}Eu_{0.1})O.MgO.5Al₂O₃ and typically used for a fluorescent lamp.

This cold cathode fluorescent lamp (Comparative Example 3) was used as a light source of backlight to prepare a liquid crystal display of this Comparative Example 3, which luminance was compared with that of this invention by displaying a white color on the liquid crystal display.

Further, when red, green and blue colors were displayed on the liquid crystal display, the emission color point (x, y) based on CIE colorimetric system of emission color was x=0.141 and y=0.080 for blue, x=0.286 and y=0.588 for green and x=0.627 and y=0.318 for red, respectively, while the NTSC ratio was 67.1%.

TABLE 3

| | Full Width | | | | |
|---|---|---|---|---|---|
| | at Half | | | | |
| | Maximum | | | | |
| | of | Peak | | | |
| Exam- | Emission | Wavelength | Emission | Emission | Relative |
| ple & | Spectrum | of Emission | Intensity | Color | Emission |
| Com- | (nm) | (nm) | Ratio | Point | Intensity |
| parative | (Δλ_{P})_{1/2} | (λ_{emP}) | (I_{G}/I_{B}) | (x/y) | (%) |
| Ex. 1 | 33 | 447.0 | 0.06 | 0.152/0.041 | 140 |
| Ex. 2 | 32 | 447.5 | 0.05 | 0.152/0.040 | 154 |
| Ex. 3 | 32 | 446.5 | 0.05 | 0.153/0.040 | 131 |
| Ex. 4 | 33 | 447.5 | 0.05 | 0.152/0.036 | 105 |
| Ex. 5 | 34 | 446.5 | 0.08 | 0.151/0.047 | 164 |
| Ex. 6 | 32 | 446.5 | 0.04 | 0.147/0.036 | 95 |
| Ex. 7 | 32 | 447.0 | 0.04 | 0.147/0.038 | 100 |
| Ex. 8 | 32 | 446.5 | 0.05 | 0.153/0.040 | 138 |
| Comp. | 32 | 447.0 | 0.04 | 0.147/0.038 | 100 |
| Ex. 1 | | | | | |
| Comp. | 61 | 448.0 | 0.43 | 0.161/0.161 | 403 |
| Ex. 2 | | | | | |

TABLE 4
COLD CATHODE FLUORESCENT LAMP (CCFL)

| | | | Luminous | | | |
|---|---|---|---|---|---|---|
| | Used Blue | Luminous | Flux | Color | Color | Emission |
| Example & | Emitting | Flux | Maintenance | Shift | Shift | Color Point |
| Comparative | Phosphor | (%) | (%) | (Δx) | (Δy) | (x/y) |
| Ex. 1 | Ex. 1 | 104.9 | 93 | 0.0034 | 0.0050 | 0.270/0.240 |
| Ex. 2 | Ex. 2 | 106.4 | 93 | 0.0037 | 0.0052 | 0.270/0.240 |
| Ex. 3 | Ex. 3 | 100.9 | 93 | 0.0039 | 0.0055 | 0.270/0.240 |
| Ex. 4 | Ex. 4 | 100.9 | 93 | 0.0037 | 0.0051 | 0.270/0.240 |
| Ex. 5 | Ex. 5 | 104.3 | 93 | 0.0023 | 0.0030 | 0.270/0.240 |
| Ex. 6 | Ex. 6 | 100.7 | 91 | 0.0040 | 0.0050 | 0.270/0.240 |
| Ex. 7 | Ex. 7 | 99.6 | 91 | 0.0032 | 0.0041 | 0.270/0.240 |
| Ex. 8 | Ex. 8 | 101.3 | 95 | 0.0031 | 0.0040 | 0.270/0.240 |
| Comp. Ex. 1 | Comp. Ex. 1 | 99.5 | 87 | 0.0087 | 0.0128 | 0.270/0.240 |
| Comp. Ex. 2 | Comp. Ex. 2 | 92.4 | 93 | 0.0015 | 0.0021 | 0.270/0.240 |
| Comp. Ex. 3 | Comp. Ex. 3 | 100.0 | 89 | 0.0082 | 0.0110 | 0.270/0.240 |

As is clear from Table 3, in the blue emitting phosphors of this invention used in Examples 1 to 6, the emission intensity ratio I_{G}/I_{B} of both emission peak intensity in the wavelength range from 445 to 455 nm and around 500 nm is lower and the calorimetric purity of blue is higher compared with the phosphor of Comparative Example 2 as a conventional alkaline earth chlorophosphate phosphor which comprises a large amount of Ba, while the luminous flux maintenance of the cold cathode fluorescent lamp using this phosphor is remarkably improved compared with the SCA phosphor of Comparative Example 1 which comprises no Ba.

Further, it is apparent from Table 4 that both the luminous flux maintenance and the color shift of the present cold cathode fluorescent lamps of Example 1 to 6 are improved compared with that of Comparative Example 1.

### Examples 7 and 8

There were prepared core phosphor slurries by adding the phosphor of Comparative Example 1 represented by the compositional formula: (Sr_{9.84}Ca_{0.01}Mg_{0.05}Eu_{0.1})(PO₄)₆Cl₂ and that of Example 3 represented by the compositional formula: (Sr_{9.7195}Ba_{0.025}Ca_{0.0055}Mg_{0.15}Eu_{0.1})(PO₄)₆Cl₂ as respective core phosphors in an amount of 100 g each and ammonium hydrogencarbonate in an amount of 3.5 g each into 300 ml of pure water, respectively, with thorough stirring.

Further, 1.2 mol/l⁻ aqueous yttrium nitrate in an amount of 2.35 ml was added to each core phosphor slurry to precipitate yttrium carbonate in the slurries, which were thoroughly stirred, filtered, washed with water, dehydrated and dried to form an Eu²⁺-activated strontium-calcium-magnesium chlorophosphate phosphor and an Eu²⁺-activated strontium-barium-calcium-magnesium chlorophosphate phosphor coated with 0.5% by weight of yttrium carbonate as phosphors of Examples 7 and 8, respectively.

Both phosphors of these examples 7 and 8 were irradiated by ultraviolet radiation at 253.7 nm to determine the emission luminance, which were 100% and 138% of the similar data of the SCA phosphor of Comparative Example 1 represented by the compositional formula: (Sr_{9.84}Ca_{0.01}Mg_{0.05}Eu_{0.1})(PO₄)₆Cl₂ determined under the same condition.

A mixing ratio of blue, green and red emitting phosphors was adjusted similarly as the cold cathode fluorescent lamp of Example 1 except that these phosphors (Examples 7, 8) were used instead of the sample of Example 1 to prepare cold cathode fluorescent lamps of these examples in which the emission color point (x, y) based on CIE calorimetric system of emission color is x=0.270 and y=0.240, respectively.

Luminous flux, luminous flux maintenance and color shift (Δx, Δy) of the cold cathode fluorescent lamps of these Examples 7, 8 are shown in Table 4.

Comparison of cold cathode fluorescent lamps of Comparative Example 1 with Example 7 as well as Comparative Example 3 with Example 8 in Table 4 shows that such coating on the surface of Eu²⁺-activated alkaline earth chlorophosphate phosphors prevents adsorption of mercury to the phosphor layer, thereby improving the luminous flux maintenance, decreasing ultraviolet degradation of the blue emitting phosphors and lowering color shift.

A liquid crystal display of Example 7 was prepared in a similar manner as described in Example 1 except that this cold cathode fluorescent lamp was used as a light source of backlight. When blue, green and red colors were displayed on the display, the emission color point (x, y) based on CIE calorimetric system of emission color was x=0.149 and y=0.063 for blue; x=0.304 and y=0.608 for green and x=0.623 and y=0.317 for red, while the range of color reproducibility was wide as NTSC ratio of 69.2%.

### Example 9

A mixing ratio of blue, green and red emitting phosphors was adjusted similarly as the cold cathode fluorescent lamp of Example 1 except that Eu³⁺-activated yttrium vanadate as a red emitting component phosphor and Eu²⁺- and Mn²⁺-coactivated barium-magnesium aluminate phosphor represented by a compositional formula: (Ba_{0.9}Eu_{0.1})O.(Mg_{0.8}Mn_{0.2})O.5Al₂O₃ as a green emitting component phosphor were used instead of the red- and green emitting phosphors used for a similar lamp of Example 1 to prepare a cold cathode fluorescent lamp of this example in which the emission color point (x, y) based on CIE calorimetric system of emission color is x=0.270 and y=0.240, respectively.

A liquid crystal display of this Example 9 was prepared in a similar manner as described in Example 1 except that this cold cathode fluorescent lamp of Example 9, was used as a light source of backlight. When blue, green and red colors were displayed on the display, the emission color point (x, y) based on CIE calorimetric system of emission color was x=0.141 and y=0.120 for blue; x=0.207 and y=0.669 for green and x=0.647 and y=0.313 for red, while the range of color reproducibility was wide as NTSC ratio of 83.8%.

### Example 10

A mixing ratio of blue, green and red emitting phosphors was adjusted similarly as the cold cathode fluorescent lamp of Example 9 except that an Eu²⁺- and Mn²⁺-coactivated barium-magnesium aluminate phosphor represented by a compositional formula: (Ba_{0.85}Eu_{0.15})O.(Mg_{0.7}Mn_{0.3})O.5Al₂O₃ was used instead of the phosphor represented by the compositional formula: (Ba_{0.9}Eu_{0.1})O.(Mg_{0.8}Mn_{0.2})O.5Al₂O₃ as the green emitting phosphors used for the lamp of Example 9 to prepare a cold cathode fluorescent lamp of this Example 10 in which the emission color point (x, y) based on CIE calorimetric system of emission color is x=0.270 and y=0.240, respectively.

A liquid crystal display of this Example 10 was prepared in a similar manner as described in Example 1 except that this cold cathode fluorescent lamp was used as a light source of backlight. When red, green and blue colors were displayed on the display, the emission color point (x, y) based on CIE colorimetric system of emission color was x=0.142 and y=0.118 for blue; x=0.210 and y=0.670 for green and x 0.647 and y=0.313 for red, while the range of color reproducibility was wide as NTSC ratio of 83.9%.

### Examples 11 to 16

A mixing ratio of blue, green and red emitting phosphors used for preparing a cold cathode fluorescent lamp was adjusted by using each of these phosphors used in Example 1 to prepare cold cathode fluorescent lamps of Examples 11 to 16 similarly as the lamp of Example 1 but each emission color point (x, y) based on CIE colorimetric system of emission color determined in these lamps was as in the following:
Example 11: x=0.23, y=0.18
Example 12: x=0.25, y=0.21
Example 13: x=0.29, y=0.27
Example 14: x=0.31, y=0.30
Example 15: x=0.33, y=0.32
Example 16: x=0.35, y=0.35

Properties of these cold cathode fluorescent lamps of Examples 11 to 16 are shown in Table 5 together with comparative data of Example 1 and Comparative Examples 4 to 9 as will be described below in which the lamps are prepared similarly as Example 1 except that the BAM phosphor is used as a blue emitting phosphor instead of the phosphor of Example 1.

The luminous flux of thus prepared lamps of these Examples 11 to 16 was higher than that of those lamps prepared by Comparative Examples 4 to 9 which are prepared similarly as Example 1 except that the BAM phosphor of Comparative Example 3 is used as a blue emitting phosphor instead of each phosphor used in Examples 11 to 16, that is, the phosphor of Example 1, as shown in Table 5.

### Comparative Examples 4 to 9

A mixing ratio of blue, green and red emitting phosphors was adjusted by using the blue emitting phosphor, the BAM phosphor, used in Comparative Example 3 instead of the phosphor as a blue emitting component of Example 1 to prepare cold cathode fluorescent lamps of Comparative Examples 4 to 9 similarly as those lamps of Examples 11 to 16 but each emission color point (x, y) based on CIE colorimetric system of emission color determined in these lamps was as in the following:
Comparative Example 4: x=0.23, y=0.18
Comparative Example 5: x=0.25, y=0.21
Comparative Example 6: x=0.29, y=0.27
Comparative Example 7: x=0.31, y=0.30
Comparative Example 8: x=0.33, y=0.32
Comparative Example 9: x=0.35, y=0.35

### Example 17

There was prepared a cold cathode fluorescent lamp of Example 17 in which the emission color point (x, y) based on CIE colorimetric system of emission color is x=0.310 and y=0.295, respectively, by using blue, green and red emitting phosphors used for the lamp of Example 1 similarly as described in Example 1 except a mixing ratio of each phosphor was changed. Then the thus obtained lamp was used similarly as the liquid crystal display of Example 1 except that this lamp was used as a light source of backlight to prepare a liquid crystal display of this example in which the emission color point (y) based on CIE calorimetric system of emission color was y=0.080 when the blue color was displayed on the liquid crystal display.

When red, green and blue colors were displayed on this liquid crystal display, the emission color point (x, y) based on CIE calorimetric system of emission color was x=0.148, y=0.080 for blue, x=0.312, and y=0.614 for green and x=0.640, y=0.325 for red, respectively, while the NTSC ratio was 70.3%.

On the other hand, the above mentioned emission color point (y) was y=0.080 when the blue color was displayed on the liquid crystal display of Comparative Example 3 comprising the cold cathode fluorescent lamp of the same Comparative Example 3 as a light source of backlight in which the blue emitting phosphor was the conventional BAM phosphor. The color reproducibility rang of green and red on the display of this Example 17 was wider compared with that of Comparative Example 3, while the display luminance of white color display on the liquid crystal display of this Example 17 was 115.6% higher than that of Comparative Example 3.

TABLE 5
COLD CATHODE FLUORESCENT LAMP (CCFL)

| | | Emission | | |
|---|---|---|---|---|
| | | Color of | | Luminous Flux |
| Example & | Used Blue emitting | CCFL (x, y) | | (Relative Value) |
| Comparative | Phosphor | x | y | (%) |
| Ex. 1 | Phosphor of Ex. 1 | 0.270 | 0.240 | 104.9 |
| Comp. Ex. 3 | Phosphor of Comp. Ex. 3 | 0.270 | 0.240 | 100.0 |
| Ex. 11 | Phosphor of Ex. 1 | 0.230 | 0.180 | 82.6 |
| Comp. Ex. 4 | Phosphor of Comp. Ex. 3 | 0.230 | 0.180 | 79.6 |
| Ex. 12 | Phosphor of Ex. 1 | 0.250 | 0.210 | 94.0 |
| Comp. Ex. 5 | Phosphor of Comp. Ex. 3 | 0.250 | 0.210 | 90.1 |
| Ex. 13 | Phosphor of Ex. 1 | 0.290 | 0.270 | 113.7 |
| Comp. Ex. 6 | Phosphor of Comp. Ex. 3 | 0.290 | 0.270 | 109.0 |
| Ex. 14 | Phosphor of Ex. 1 | 0.310 | 0.300 | 122.6 |
| Comp. Ex. 7 | Phosphor of Comp. Ex. 3 | 0.310 | 0.300 | 117.7 |
| Ex. 15 | Phosphor of Ex. 1 | 0.330 | 0.320 | 125.3 |
| Comp. Ex. 8 | Phosphor of Comp. Ex. 3 | 0.330 | 0.320 | 120.8 |
| Ex. 16 | Phosphor of Ex. 1 | 0.350 | 0.350 | 130.3 |
| Comp. Ex. 9 | Phosphor of Comp. Ex. 3 | 0.350 | 0.350 | 125.7 |

1. In a cold cathode fluorescent lamp in which a phosphor layer is formed on an inner wall of a transparent envelope and mercury and rare gas are encapsulated in said envelope, said phosphor layer being emitted by ultraviolet wavelength of 180 to 300 nm irradiated by discharging said mercury, said phosphor layer comprises an alkaline earth chlorophosphate phosphor used for a blue emitting cold cathode fluorescent lamp and is represented by the following compositional formula:
(Sr₁₀₋ₖ₋ₗ₋ₘ₋ₙBaₖCaₗMgₘEuₙ)(PO₄)₆Cl₂
wherein k, l, m and n are numeral value satisfied by conditions of 0≦k≦1.5, 0≦1≦1.2, 0≦m≦0.25 and 0.05≦n≦0.3, respectively.

2. A cold cathode fluorescent lamp claimed in claim 1 in which k is numeral value satisfied by a condition of 0<k≦1.5.

3. A cold cathode fluorescent lamp claimed in claim 1 in which k is numeral value satisfied by a condition of 0.005≦k≦1.5.

4. A cold cathode fluorescent lamp claimed in claim 1 emitting an emission in which emission spectral peak wavelength (λₑₘₚ) of an alkaline earth chlorophosphate phosphor used for said blue emitting cold cathode fluorescent lamp is in a wavelength range of 445 to 455, full width at half maximum (Δλₚ)_{1/2} of the emission peak thereof is 35 nm or less and color point (x, y) of CIE calorimetric system of emission color is 0.14≦x≦0.16 and 0.02≦y≦0.06.

5. A cold cathode fluorescent lamp claimed in claim 4 in which emission intensity ratio (I_{G}/I_{B}) is 0.12 or less wherein I_{B} and I_{G} represent emission intensity at said emission spectral peak wavelength (λₑₘₚ) and at 500 nm of said emission spectrum, respectively.

6. A cold cathode fluorescent lamp claimed in claim 1 in which particle surface of said alkaline earth chlorophosphate phosphor used for a blue emitting cold cathode fluorescent lamp is coated with at least one of metal oxide, hydroxide or carbonate compounds.

7. A cold cathode fluorescent lamp claimed in claim 1 in which said phosphor layer comprises a green emitting phosphor having a emission peak in the wavelength range of 505 to 535 nm.

8. A cold cathode fluorescent lamp claimed in claim 7 in which said green emitting phosphor is an Eu²⁺- and Mn²⁺-coactivated alkaline earth aluminate phosphor.

9. A cold cathode fluorescent lamp claimed in claim 8 in which said Eu²⁺- and Mn²⁺-coactivated alkaline earth aluminate phosphor is represented by the following compositional formula:
a(P_{1-c}Eu_{c})O.(Q_{1-d}Mn_{d})O.bAl₂O₃
wherein P represents at least one of alkaline earth metal elements including Ba, Sr and Ca, Q represents at least one of divalent metal elements including Mg and Zn, and a, b, c and d represent numeral value satisfied by conditions of 0.8≦a≦1.2, 4.5≦b≦5.5, 0.05≦c≦0.25 and 0.2≦d≦0.4, respectively.

10. A cold cathode fluorescent lamp claimed in claim 7 in which said phosphor layer comprises a red emitting phosphor showing an emission peak in the wavelength range from 610 to 630 nm n.

11. A cold cathode fluorescent lamp claimed in claim 10 in which said red emitting phosphor is at least one of Eu³⁺-activated rare earth oxide phosphors, Eu³⁺-activated rare earth vanadate phosphors and Eu³⁺-activated rare earth phosphate-vanadate phosphors.

12. A cold cathode fluorescent lamp claimed in claim 1 in which the emission color point (x, y) of CIE calorimetric system of emission color is in the range of 0.23≦x≦0.35, 0.18≦y≦0.35.

13. In a color liquid crystal display device incorporated with plural liquid crystal elements consisted of liquid crystals which function as an optical shutter, a color filter corresponding to each of said plural liquid crystal elements and having at least three coloring matters of red, green and blue and a backlight for transmittance type lighting, said backlight comprises a cold cathode fluorescent lamp claimed in claim 1.

14. A blue emitting alkaline earth chlorophosphate phosphor used for a cold cathode fluorescent lamp which compositional formula is represented by
(Sr₁₀₋ₖ₋ₗ₋ₘ₋ₙBaₖCaₗMgₘEuₙ)(PO₄)₆Cl₂
wherein k, l, m and n are numeral value satisfied by conditions of 0<k≦1.5, 0≦1≦1.2, 0≦m≦0.25 and 0.05≦n≦0.3, respectively.

15. A blue emitting alkaline earth chlorophosphate phosphor claimed in claim 14 in which said k is numeral value satisfied by a condition of 0.005≦k≦1.5.

16. A blue emitting alkaline earth chlorophosphate phosphor claimed in claim 14 in which emission spectral peak wavelength is 445 to 455 nm, full width at half maximum of a emission peak thereof is 35 nm or less and emission color point (x, y) of CIE colorimetric system of emission color is in the range of 0.14≦x≦0.16 and 0.02≦y≦0.06.

17. A blue emitting alkaline earth chlorophosphate phosphor claimed in claim 14 in which an emission intensity ratio ((I_{G}/I_{B}) is 0.12 wherein I_{B} and I_{G} represent emission intensity of emission spectral peak in said wavelength range and at 500 nm, respectively.

18. A blue emitting alkaline earth chlorophosphate phosphor claimed in claim 14 which surface is coated with at least one of metal oxide, hydroxide and carbonate compounds.
